(19) United States
(12) Patent Application Publication
(10) Pub. No.: US 2012/0030759 A1
(43) Pub. Date: Feb. 2, 2012

(54) SECURITY PROTOCOL FOR DETECTION OF FRAUDULENT ACTIVITY EXECUTED VIA MALWARE-INFECTED COMPUTER SYSTEM

(75) Inventors: Stuart O. Goldman, Scottsdale, AZ (US); Robert Joseph Thornberry, JR., Wheaton, IL (US)

(73) Assignee: Alcatel-Lucent USA Inc., Murray Hill, NJ (US)

(21) Appl. No.: 12/845,249

(22) Filed: Jul. 28, 2010

(51) Int. Cl. G06F 21/20

(52) U.S. Cl. 726/23

(57) ABSTRACT

A security protocol is disclosed for detecting occurrences of intruder activity, including hidden or concealed activity that may occur in a computer system including a host platform operably connected to an application platform. The protocol relies on parameters defining a tag sequence and syntax commonly known to the application platform and host platform (and hence the user) to detect occurrences of intruder activity during the session.

### FIELD OF THE INVENTION

This invention relates generally to computer security and, more particularly to a security protocol for detecting fraudulent activity (e.g., occurring after establishment of a session) executed via a malware-infected computer system.

### BACKGROUND OF THE INVENTION

Security is one of the most important concerns in virtually all computer systems, e.g., the ability to protect information and system resources from intrusions from hackers, malware, viruses, worms or the like. This concern is particularly worrisome when computing platforms are networked within Internet Protocol (IP)-based networks that can be accessed by untrusted users/devices and thereby open windows of vulnerability to the computing platforms. Once a computer platform is infected, it can be exploited to perform various forms of malicious or undesirable activity, which frequently can be concealed or hidden to the user.

For example, a “trojan horse” (or “trojan”) is a type of malware, typically disguised or bundled with software that appears to be innocuous or desirable, but once installed on a host computer can enable an intruder to execute virtually any command or perform any activity that is available to the authorized user of the host computer while remaining concealed from the authorized user. And such activity may include access to seemingly secure domains protected by authentication protocols, passwords and the like.

For example and without limitation, one-time password generators (e.g., tokens) are devices or software that are often used for purpose of user authentication and access to computer accounts associated with banking transactions, brokerage accounts and the like. Most typically, the token generates a six-digit numerical sequence every 30 or 60 seconds, and when a user desires to access a particular account, the user enters a personal identification number (PIN) concatenated with a currently displayed sequence. At the remote application platform, an authentication entity calculates one-time-password sequences using the same mathematical algorithm as the token, and can therefore authenticate a valid user if the sequence entered by the user associated with a particular PIN matches the corresponding sequence generated by the authentication entity. In such manner a user can establish a seemingly secure session with a banking or other financial service applications or the like. Of course, any of several alternative security schemes (e.g., using static passwords or the like) may also be employed for establishment of a session.

However, a problem that arises, irrespective of the security measures that are employed to authenticate a user and establish a seemingly secure session between a host platform and a remote application platform, a trojan horse or other like malware infecting a host computer can enable an intruder to exchange commands with the remote application platform during the session, and the activity may be hidden or concealed from the user. For example and without limitation, the intruder may issue commands to the remote application platform using the malware as a gateway, or the malware may issue commands directly on behalf of the intruder by executing code programmed by the intruder.

Accordingly, there is a need to develop an additional layer of security to detect in-session fraudulent activity executed via a host computer, advantageously including hidden or concealed activity executed via a trojan program or other like malware infecting the host computer.

### SUMMARY OF THE INVENTION

This need is addressed by structures and methods disclosed herein for detecting occurrences of intruder activity, including hidden or concealed activity that may occur in a computer system including a host platform operably connected to an application platform, wherein the host platform is associated with a valid user that may exchange one or more user commands with the application platform, but wherein the host platform is subject to intrusion by a malware component that may exchange one or more intruder commands with the application platform.

In one embodiment, there is provided a method performed by the host platform. The host platform receives one or more user commands issued to the application platform and communicates the user commands to the application platform, at least a portion of the user commands including sequential tags of a tag sequence inserted by the user for use in detecting occurrences of intruder activity during the session. Thereafter, the host platform receives indicia of possible intruder activity from the application platform based on the application platform having received a user command with an out-of-sequence tag relative to that of a most recent session command or the application platform having received a session command with an out-of-sequence tag relative to that of a most recent user command.

In another embodiment, there is provided an apparatus for detecting possible intruder activity at the host platform. The apparatus comprises a memory and at least one processor coupled to the memory and configured to receive one or more user commands issued to the application platform and communicate the user commands to the application platform, at least a portion of the user commands including sequential tags of a tag sequence inserted by the user for use in detecting occurrences of intruder activity during the session. Thereafter, the apparatus receives indicia of possible intruder activity from the application platform based on the application platform having received a user command with an out-of-sequence tag relative to that of a most recent session command or the application platform having received a session command with an out-of-sequence tag relative to that of a most recent user command.

In still another embodiment, there is provided a method performed by the application platform. The application platform obtains one or more fraud detection protocol parameters defining a tag sequence for use in detecting occurrences of intruder activity during the session; and receives one or more session commands issued from the host platform, at least a portion of the session commands comprising user commands including sequential tags of the tag sequence inserted by the user. The application platform checks the session commands for indicia of possible intruder activity, wherein possible intruder activity is positively indicated based on detecting an improper tag sequence between consecutively received session commands.

In another embodiment, there is provided an apparatus for detecting possible intruder activity at the application platform. The apparatus comprises a memory and at least one processor coupled to the memory and configured to obtain one or more fraud detection protocol parameters defining a tag sequence for use in detecting occurrences of intruder activity during the session; and receive one or more session commands issued from the host platform, at least a portion of the session commands comprising user commands including sequential tags of the tag sequence inserted by the user. The apparatus checks the session commands for indicia of possible intruder activity, wherein possible intruder activity is positively indicated based on detecting an improper tag sequence between consecutively received session commands.

In yet another embodiment, there is provided a method carried out by a valid user of the host platform operably connected to an application platform. The user establishes a session between the host platform and the application platform; and during the session, sends one or more user commands to the application platform via the host platform, at least a portion of the user commands including sequential tags of a tag sequence inserted by the user for use in detecting occurrences of intruder activity during the session. Thereafter, the user receives indicia of possible intruder activity from the application platform via the host platform, wherein possible intruder activity is positively indicated based on the application platform having received a user command with an out-of-sequence tag relative to that of a most recent session command; or the application platform having received a session command with an out-of-sequence tag relative to that of a most recent user command.

In still yet another embodiment, there is provided a method carried out by the host platform operably connected to an application platform. The host platform obtains one or more fraud detection protocol parameters defining a tag sequence for use in detecting occurrences of intruder activity during the session; receives one or more messages issued from the application platform, at least a portion of the messages including sequential tags of the tag sequence inserted by the application platform; and checks for indicia of possible intruder activity, wherein possible intruder activity is positively indicated based on detecting an improper tag sequence between consecutively received messages.

### BRIEF DESCRIPTION OF THE DRAWINGS

The foregoing and other advantages of the invention will become apparent upon reading the following detailed description and upon reference to the drawings in which:

FIG. 1 is a block diagram of a computer system operable to execute a fraud detection protocol for detecting unauthorized activity by a trojan program or other like malware.

FIG. 2 is a flowchart showing steps performed by a host platform to execute a fraud detection protocol of the type shown in FIG. 1; and

FIG. 3 is a flowchart showing steps performed by an application platform to execute a fraud detection protocol of the type shown in FIG. 1.

### DESCRIPTION OF THE PREFERRED EMBODIMENT(S)

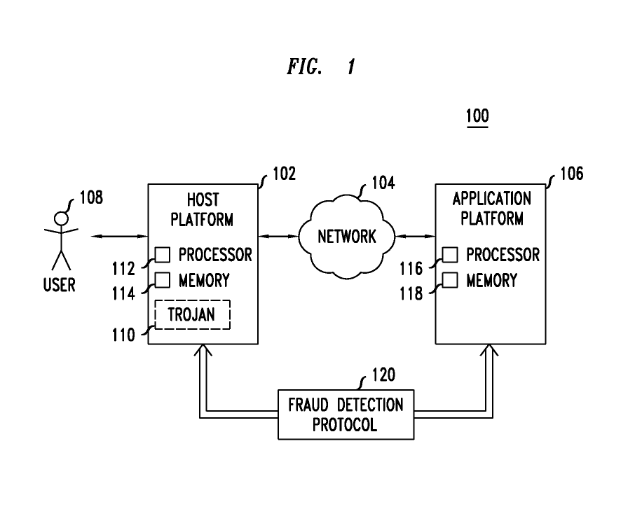

FIG. 1 depicts a computer system 100 including a host platform 102 interconnected by a communication network 104 to a remote application platform 106. The host platform 102 may comprise, for example and without limitation, a laptop computer, desktop computer or mobile computing device operable to execute transactions with the application platform 106; and the application platform 106 may comprise, for example and without limitation, a web-based platform, or platform residing internal to the firewall of a business or government enterprise to perform some kind of activity or transaction with the host platform. The network 104 comprises generally any communication medium operable to link the host platform 102 to the application platform 106. The network 102 may comprise, without limitation, an IP Multimedia Subsystem (IMS) network, a wireless network (e.g., CDMA-based or GSM-based network), a circuit-switched network, a packet-based network (IP network) or another type of network.

The activity or transactions performed by the application platform may include, without limitation, banking or financial transactions, e-commerce, gaming, communications or social networking transactions nominally initiated by a valid user 108 of the host platform 102. Most typically, the activity or transaction occurs following an authentication procedure in which the user 108 supplies passwords or the like to establish a seemingly secure session with the application platform 106. However, in cases where the host platform is infected with a malware component 110 (as shown, a “trojan” program), an intruder may issue unauthorized commands during the session to perform fraudulent transactions with the application platform.

The host platform 102 and application platform 104 each include a processor and memory for effecting transactions or segments of transactions during an active session. As shown, the host platform 102 includes processor 112 and memory 114; and the application platform 104 includes processor 116 and memory 118. Generally, the processors 112, 116 are operable to execute respective program code (e.g., including but not limited to operating system firmware/software and application software) stored in the respective memory 114, 118, the execution of which depends at least in part from commands issued from the user 108 and, possibly, if the host platform is infected with a malware component 110, from intruder commands issued via the malware component 110, which are often hidden or concealed from the user.

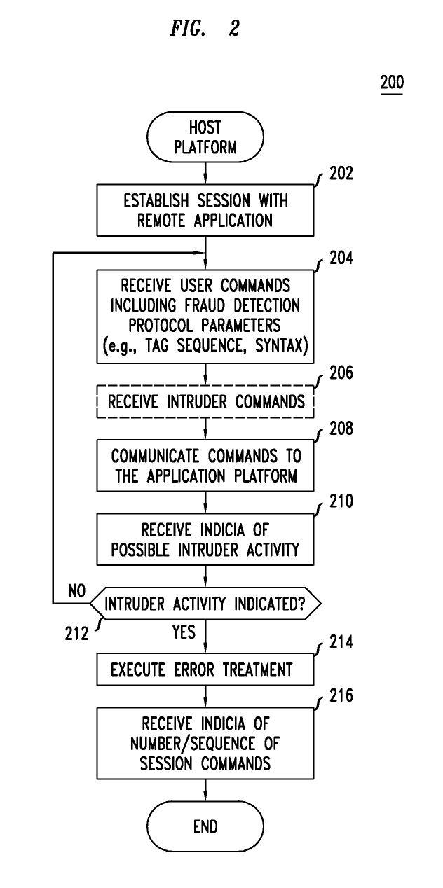

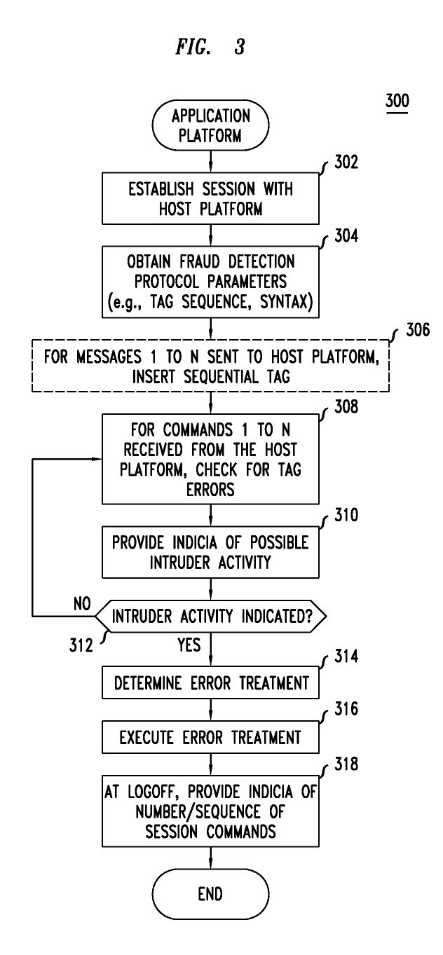

However, according to embodiments of the present invention, the computer system 100 implements a fraud detection protocol 120 to detect transactions or segments of transactions that may be executed via a malware component 110 during an active session. The fraud detection protocol include steps performed, where applicable, by the host platform 102, the application platform 106 and the user 108 to detect instances of possible intruder activity (e.g., from the trojan 110). In one embodiment, as will be described in greater detail in relation to FIG. 2 and FIG. 3, the fraud detection protocol relies on parameters defining a tag sequence and syntax commonly known to the application platform and host platform (and hence the user) to detect occurrences of intruder activity during the session.

The tag sequence comprises, in an example implementation, a simple numerical sequence (e.g., 1, 2, 3, 4, etc.) and the syntax prescribes insertion of a designated character (e.g., #) following each number to be inserted in commands or messages exchanged between the host platform and application platform, such that the numerical tags are distinguishable from other numbers that may appear in the commands or messages. As will be appreciated, however, any of several alternative tag sequences may be employed with varying degrees of complexity including alpha-numeric sequences, character sequences, more complex mathematical sequences or the like depending on the particular application and/or the nature of the application. Moreover, the tag sequence may characterize an algorithm for deriving consecutive tags of the tag sequence, or may be generated by devices or software similarly to one-time password generators to establish tags during the session.

FIG. 2 is a flowchart showing steps performed by the host platform, in conjunction with the user 108 where applicable, to execute a fraud detection protocol. For example and without limitation, the steps of FIG. 2 may be performed by a laptop computer, desktop computer or mobile computing device operated by the valid user 108 to execute some kind of activity or transaction with the application platform, but which is subject to intrusion from the trojan 110 so as to compromise the activity or transaction with one or more intruder commands.

At step 202, a session is established between the host platform and the remote application to enable the activity or transaction. For example and without limitation, a session may be established between the host platform and the remote application platform responsive to the valid user 108 communicating a one-time password sequence and PIN, static password, or other suitable security parameters to the application platform, and the application platform thereafter authenticating the user based on the supplied security parameters. As will be appreciated, depending on the particular application and/or the nature of the application, a session may be established via any of several authentication schemes, having varying degrees of complexity and utilizing fewer, greater, or different types of security parameters.

In one embodiment, coincident to establishing the session at step 202, the host platform (and hence the user of the host platform) receives fraud detection protocol parameters defining a tag sequence and syntax for use in detecting occurrences of intruder activity during the session. The fraud detection protocol parameters may be received from the application platform or from a trusted third party platform, such as a subroutine residing between the host platform and application platform, provided the fraud detection protocol parameters are known to both the host platform and application platform.

At step 204, the host platform receives one or more user commands issued to the application platform, wherein at least a portion of the user commands include sequential tags of the tag sequence inserted by the user. The user commands comprise generally any instance of communication from the user, including without limitation, keystrokes, keystroke or keypad combinations or representations that convey instructions or information to the application platform coincident to a transaction or segment of a transaction.

At step 206 (in case the host platform is infected with a malware component), it is possible that the host platform will receive one or more intruder commands issued to the application platform, so as to convey fraudulent instructions or information to the application platform appearing to originate from the user. It is contemplated that the intruder commands may even include sequential tags of the tag sequence so as to appear to originate from the valid user.

At step 208, the host platform communicates the user commands and intruder commands, if applicable (and their associated tags) to the application platform. In one embodiment, responsive to receiving the user commands from the host platform, the application platform performs a check for possible intruder activity based on the tag sequence of the user commands (and intruder commands, if applicable) received from the host platform, and provides indicia of possible intruder activity to the host platform.

At step 210, the host platform receives indicia of possible intruder activity from the application platform. For example and without limitation, the application platform may display error messages or the like if possible intruder activity is positively indicated or indicia of success if possible intruder activity is not positively indicated.

In one embodiment, possible intruder activity is positively indicated based on one or more of the following:

(1) the application platform having received a user command with an out-of-sequence tag relative to that of a most recent session command; or

(2) the application platform having received a session command with an out-of-sequence tag relative to that of a most recent user command.

For example and without limitation, consider a banking transaction wherein at least a portion of the user commands issued to the application platform comprise data entry fields associated with electronic bill payment, such as, for example, payment amounts, payee addresses or the like. Suppose the tag sequence commonly known to the user and the application platform comprises an ordered numerical sequence and syntax (e.g., 1#, 2#, 3#, 4#, etc.); and the tag sequence and syntax may also be known to an intruder.

Suppose the user issues the following commands (and their associated tags) to the application platform via the host platform:

[From “Add Payee” Screen]

1# John Q. Payee

2# 531 Main St

3# Anytown, USA

The user has thus entered sequential tags in consecutive data entry fields (“user commands”) to add a valid payee and payee address for delivery to the application platform. Note that in this exemplary embodiment, it is contemplated that the user would also enter mouse commands, for example, “clicks” of the mouse to navigate to the “add payee” screen. However, the user did not enter tags in association with the mouse commands Thus, to the extent that mouse commands are considered user commands, the user has entered tags in only a portion of the user commands (i.e., only the data entry commands). Nevertheless, it is contemplated that the fraud detection protocol parameters known to the user and the application platform will define which types of commands (e.g., in this example, only the data entry commands) are to include instances of the tag sequence.

Now consider that the host platform is infected with a malware component that may exchange one or more intruder commands with the application platform. It is contemplated that the intruder may attempt to modify or supplement the user commands to enter, for example, a fraudulent payee address. And most typically the fraudulent commands will be hidden from the user. Note that a sophisticated intruder may be aware of the tag sequence as well as the most recent tag (e.g., “3#”) inserted by the user. In such case, the intruder may send the following commands (and their associated tags) to the application platform via the host platform to enter a fraudulent payee address associated with an otherwise valid payee.

[From “Add Payee” Screen]

4# 141 Mountain Avenue

5# New York, N.Y.

Now suppose the valid user proceeds to enter another command to the application platform via the host platform. From the perspective of the user, who is not aware of the intruder commands, the next consecutive tag of the sequence is #4. So the user may issue the following command:

[From “Pay Bill” Screen]

4# 20.00

The user has thus entered a sequential tag from its own perspective, but which tag has been previously used by an intruder to attempt a fraudulent transaction. Thus, the application platform will have received a user command with an out of sequence tag (“4#”) relative to the most recent session command (“5#”) received by the application platform, indicating possible intruder activity. Possible intruder activity may also be positively indicated in instances where the application platform receives a session command with an out-of-sequence tag relative to that of a most recent user command (as would be the case, for example, if the intruder commands in the present example were initiated with tag #1. Possible intruder activity may also be indicated in cases where the application platform receives a session command with an improper tag syntax (e.g., “4” rather than “4#”). [The term “possible intruder activity” is used herein, rather than “intruder activity” to allow for instances, for example, where user mistakenly enters a tag that is out of sequence or has improper syntax.]

If possible intruder activity is not indicated, determined at step 212, the process returns to step 308 to continue to receive further user commands and, if present, intruder commands. But if possible intruder activity is positively indicated, the host platform executes an error treatment determined by the application at step 214. For example and without limitation, the application may end the session and capture data, or the like to enable further investigation of the possible intruder activity; or the application may allow the user to try again a predetermined number of times before ending the session.

At step 216, the host platform (and hence the user) receives from the application platform, indicia of the number and sequence of session commands, as a further check for possible intruder activity. In one embodiment, such indicia is received responsive to issuing a final “logoff” command (and associated tag) issued by the user via the host platform. In such manner, a user can determine whether any hidden commands were executed during the session even if the user did not receive indicia of intruder activity during the session (such as might occur if the user only initiated a single command during the session).

Now turning to FIG. 3, there is shown a flowchart of steps performed by an application platform to execute a fraud detection protocol. The application platform may comprise, for example, any computer device or software application residing remotely from a host platform that executes an application program to perform some kind of activity or transaction with a user.

At step 302, a session is established between the host platform and the remote application to enable the activity or transaction. For example and without limitation, a session may be established between the host platform and the remote application platform responsive to the valid user 108 communicating a one-time password sequence and PIN, static password, or other suitable security parameters to the application platform, and the application platform thereafter authenticating the user based on the supplied security parameters. As will be appreciated, depending on the particular application and/or the nature of the application, a session may be established via any of several authentication schemes, having varying degrees of complexity and utilizing fewer, greater, or different types of security parameters.

At step 304, the application platform obtains fraud detection protocol parameters defining a tag sequence and syntax for use in detecting occurrences of intruder activity during the session. In one embodiment, the fraud detection protocol parameters are provided by the application platform to the host platform, so that common parameters are known to both the host platform and the application platform. Alternatively or additionally, fraud detection protocol parameters may be provided to the application platform and the host platform by a third party platform, such as a subroutine residing between the host platform and application platform.

Optionally, at step 306, the application platform may include sequential tags of the tag sequence in one or more messages sent to the host platform during the session. In one embodiment, responsive to receiving such messages from the application platform, the host platform (or user of the host platform) may check for possible intruder activity based on the tag sequence of the messages received from the application platform.

At step 308, the application platform receives one or more commands (“session commands”) from the host platform and checks for tag errors indicating possible intruder activity. The session commands comprise at least in part user commands having sequential tags of the tag sequence inserted by the user, and (in case the host platform is infected with a malware component) may include intruder commands. Depending on sophistication of the intruder, the intruder commands may have sequential tags of the tag sequence inserted by the intruder so as to appear to originate from the valid user. In one embodiment, possible intruder activity is positively indicated based on detecting an improper tag sequence between consecutively received session commands.

For example, referring to the exemplary banking transaction described in relation to FIG. 2, the application platform receives the following session commands (and their associated tags), in sequence:

[From the user]

1# John Q. Payee

2# 531 Main St

3# Anytown, USA

[From the intruder]

4# 141 Mountain Avenue

5# New York, N.Y.

[From the user]

4# 20.00

The application platform can not distinguish user commands from intruder commands, but can nevertheless detect possible intruder activity based on the improper tag sequence (e.g., tag “4#” being out of sequence with the previous session tag “5#”).

At step 310, the application platform provides indicia of possible intruder activity to the host platform. For example and without limitation, the application platform may display error messages or the like if possible intruder activity is positively indicated or indicia of success if possible intruder activity is not positively indicated.

If possible intruder activity is not indicated, determined at step 312, the process returns to step 308 to continue to receive further session commands. But if possible intruder activity is positively indicated, the application platform determines an error treatment at step 314 and executes the error treatment at step 316. For example and without limitation, the application may end the session and capture data, or the like to enable further investigation of the possible intruder activity; or the application may allow the user to try again a predetermined number of times before ending the session.

At step 318, the application platform provides indicia of the number and sequence of session commands to the host platform (and hence the user), as a further check for possible intruder activity. In one embodiment, such indicia is issued responsive to receiving a final “logoff” command (and associated tag) issued by the user via the host platform. In such manner, a user can determine whether any hidden commands were executed during the session even if the user did not receive indicia of intruder activity during the session (such as might occur if the user only initiated a single command during the session).

FIGS. 1-3 and the foregoing description depict specific exemplary embodiments of the invention to teach those skilled in the art how to make and use the invention. The described embodiments are to be considered in all respects only as illustrative and not restrictive. The present invention may be embodied in other specific forms without departing from the scope of the invention which is indicated by the appended claims. All changes that come within the meaning and range of equivalency of the claims are to be embraced within their scope.

For example, the term “host platform” as used herein is generally defined as any computer device including, without limitation, laptop computer, desktop computer, personal computer (PC), or mobile computing device, including, without limitation, personal digital assistant (PDA), tablet PC or mobile phone, nominally operated by a valid user and being operable to execute transactions with a remote application platform responsive to exchanging one or more user commands between the host platform and application platform, but which is subject to intrusion by a malware component that may exchange one or more intruder commands with the application platform.

The term “application platform” as used herein is generally defined as any computer device or software application residing remotely from the host platform that executes an application program to perform some kind of activity or transaction with a user. Most typically, the activity or transaction occurs following an authentication procedure in which the user supplies passwords or the like to gain access to the application platform and to establish a seemingly secure session. However, in cases where the host platform is infected with a malware component, an intruder may issue unauthorized commands during the session to perform fraudulent transactions with the application platform. The application platform may include, without limitation, web-based platforms, or platforms residing internal to the firewall of a business or government enterprise; and the activity or transaction may include, without limitation, banking or financial transactions, e-commerce, gaming, communications or social networking transactions.

The terms “user commands” and “intruder commands” as used herein is generally defined as any instance of communication from the user, or from an intruder, respectively, to an application platform that causes the application platform to perform some sort of transaction or segment of a transaction. Commands may include, without limitation, user keystrokes, keystroke combinations, or keystroke representations (e.g., ASCII representations of user keystrokes or combinations), keypad entries or combinations or representations thereof, conveying instructions or information to the application platform.

What is claimed is:

1. In a computer system including a host platform operably connected to an application platform, wherein the host platform is associated with a valid user that may exchange one or more user commands with the application platform, but wherein the host platform is subject to intrusion by a malware component that may exchange one or more intruder commands with the application platform, a method comprising the host platform:
receiving one or more user commands issued to the application platform, at least a portion of the user commands including sequential tags of a tag sequence inserted by the user for use in detecting occurrences of intruder activity during the session;
communicating the user commands to the application platform; and
receiving indicia of possible intruder activity from the application platform, wherein possible intruder activity is positively indicated based on at least one of:
the application platform having received a user command with an out-of-sequence tag relative to that of a most recent session command;
the application platform having received a session command with an out-of-sequence tag relative to that of a most recent user command.

2. The method of claim 1, wherein the step of receiving indicia of possible intruder activity is positively indicated further based on the application platform having received a session command with an improper tag syntax.

3. The method of claim 1, further comprising the host platform:
receiving indicia that possible intruder activity is positively indicated; and
receiving indicia of an error treatment associated with the activity; and
executing the error treatment.

4. The method of claim 1, performed during a session having been established by the user between the host platform and the application platform.

5. The method of claim 4, further comprising:
during the session, receiving one or more messages from the application platform via the host platform, at least a portion of the messages including sequential tags of the tag sequence inserted by the application platform; and
checking for indicia of possible intruder activity, wherein possible intruder activity is positively indicated based on detecting an improper tag sequence between consecutively received messages from the application platform.

6. In a computer system including a host platform operably connected to an application platform, wherein the host platform is associated with a valid user that may exchange one or more user commands with the application platform, but wherein the host platform is subject to intrusion by a malware component that may exchange one or more intruder commands with the application platform, a method comprising the application platform:
obtaining one or more fraud detection protocol parameters defining a tag sequence for use in detecting occurrences of intruder activity during the session;
receiving one or more session commands issued from the host platform, at least a portion of the session commands comprising user commands including sequential tags of the tag sequence inserted by the user; and
checking for indicia of possible intruder activity, wherein possible intruder activity is positively indicated based on detecting an improper tag sequence between consecutively received session commands.

7. The method of claim 6, wherein the fraud detection protocol parameters further define a tag syntax, the step of checking for indicia of possible intruder activity further comprises checking for proper tag syntax, and wherein possible intruder activity is positively indicated based on detecting an improper tag syntax of a received session command.

8. The method of claim 6, further comprising the application platform:
detecting possible intruder activity;
determining an error treatment associated with the activity; and
executing the error treatment.

9. The method of claim 6, further comprising the application platform:
sending one or more messages to the host platform, at least a portion of the messages including sequential tags of the tag sequence inserted by the application platform to enable the user to check for indicia of possible intruder activity, wherein possible intruder activity is positively indicated based on detecting an improper tag sequence between consecutively received messages from the application platform.

10. Apparatus for detecting possible intruder activity, in accordance with a computer system including a host platform operably connected to an application platform, wherein the host platform is associated with a valid user that may exchange one or more user commands with the application platform, but wherein the host platform is subject to intrusion by a malware component that may exchange one or more intruder commands with the application platform, the apparatus at the host platform comprising:
a memory; and
at least one processor coupled to the memory and configured to:
receive one or more user commands issued to the application platform, at least a portion of the user commands including sequential tags of a tag sequence inserted by the user for use in detecting occurrences of intruder activity during the session;
communicate the user commands to the application platform; and
receive indicia of possible intruder activity from the application platform, wherein possible intruder activity is positively indicated based on at least one of:
the application platform having received a user command with an out-of-sequence tag relative to that of a most recent session command;
the application platform having received a session command with an out-of-sequence tag relative to that of a most recent user command.

11. Apparatus for detecting possible intruder activity, in accordance with a computer system including a host platform operably connected to an application platform, wherein the host platform is associated with a valid user that may exchange one or more user commands with the application platform, but wherein the host platform is subject to intrusion by a malware component that may exchange one or more intruder commands with the application platform, the apparatus at the application platform comprising:
a memory; and
at least one processor coupled to the memory and configured to:
obtain one or more fraud detection protocol parameters defining a tag sequence for use in detecting occurrences of intruder activity during the session;
receive one or more session commands issued from the host platform, at least a portion of the session commands comprising user commands including sequential tags of the tag sequence inserted by the user; and
check for indicia of possible intruder activity, wherein possible intruder activity is positively indicated based on detecting an improper tag sequence between consecutively received session commands.

12. A method, carried out by a valid user of a host platform operably connected to an application platform, wherein the host platform is subject to intrusion by a malware component that may exchange one or more intruder commands with the application platform, the method comprising:
establishing a session between the host platform and the application platform;
during the session, sending one or more user commands to the application platform via the host platform, at least a portion of the user commands including sequential tags of a tag sequence inserted by the user for use in detecting occurrences of intruder activity during the session; and
receiving indicia of possible intruder activity from the application platform via the host platform, wherein possible intruder activity is positively indicated based on at least one of:
the application platform having received a user command with an out-of-sequence tag relative to that of a most recent session command;
the application platform having received a session command with an out-of-sequence tag relative to that of a most recent user command.

13. The method of claim 12, further comprising:
during the session, receiving one or more messages from the application platform via the host platform, at least a portion of the messages including sequential tags of the tag sequence inserted by the application platform; and
checking for indicia of possible intruder activity, wherein possible intruder activity is positively indicated based on detecting an improper tag sequence between consecutively received messages from the application platform.

14. In a computer system including a host platform operably connected to an application platform, wherein the host platform is associated with a valid user that may exchange one or more user commands with the application platform, but wherein the host platform is subject to intrusion by a malware component that may exchange one or more intruder commands with the application platform, a method comprising the host platform:
obtaining one or more fraud detection protocol parameters defining a tag sequence for use in detecting occurrences of intruder activity during the session;
receiving one or more messages issued from the application platform, at least a portion of the messages including sequential tags of the tag sequence inserted by the application platform; and
checking for indicia of possible intruder activity, wherein possible intruder activity is positively indicated based on detecting an improper tag sequence between consecutively received messages.
